(19) United States
(12) Patent Application Publication
(10) Pub. No.: US 2014/0285437 A1
(43) Pub. Date: Sep. 25, 2014

(54) METHOD OF INTERNET BROWSER-BASED REMOTE USER INTERFACE VIRTUAL MOUSE CURSOR POSITIONING

(71) Applicants: Zuoshu Lu, Morris Plains, NJ (US); Jun Li, Cranbury, NJ (US); Jun Xu, Beijing (CN)

(72) Inventors: Zuoshu Lu, Morris Plains, NJ (US); Jun Li, Cranbury, NJ (US); Jun Xu, Beijing (CN)

(73) Assignee: THOMSON LICENSING, Issy de Moulineaux (FR)

(21) Appl. No.: 14/353,576

(22) PCT Filed: Oct. 28, 2011
(86) PCT No.: PCT/CN2011/081510

§ 371 Date: Apr. 23, 2014

(51) Int. Cl. G06F 3/0354

(52) U.S. Cl. CPC G06F 3/03543
USPC 345/163

(57) ABSTRACT

A method is described including receiving, by a remote browser, local mouse information and local window size, calculating a virtual mouse position and displaying the virtual mouse position on a window of the remote browser. Also described is a method including transmitting local mouse information and local window size to a Web Socket Server. Further described is a method including forwarding by a Web Socket Server local mouse information and local window size to a remote browser.

### FIELD OF THE INVENTION

The present invention relates to mouse cursor positioning. Specifically, the present invention is directed to how to interpret the mouse position in the local browser in order to determine the virtual mouse position on the remote browser.

### BACKGROUND OF THE INVENTION

The present invention is a method for a browser-based remote user interface (UI) (such as HTML5) to support virtual mouse cursor functionality and improve the flexibility of object control among multiple UIs. One deficiency of the prior art browser-based remote UI is that it does not explicitly define a fixed size browser window. Since it is possible that the browser sizes of two UIs are different, without proper scaling information, it is not possible to position or overlay a virtual mouse cursor of a second UI on a first UI that does not share the same resolution or aspect ratio as the second UI.

Remote UI technology allows one to control another UI remotely via Internet or local area networks, such as windows' Remote Desktop and Logmein. However, Remote Desktop logs out the remote computer when the local user tries to access the remote computer. Logmein software provides a web browser-based remote UI to users, it does not log out the remote computer, but it renders a desktop screenshot of the remote computer as a whole image. There is no media relationship between the remote UI and the local UI. The remote UI is simply a window on the local UI.

With a HTML5-based remote UI technology, or CE-HTML, one can play the same media (video, radio) simultaneously with full quality of pictures and sounds on multiple UIs on different computers. Users can also drag a Picture-in-Picture video from one UI to another UI on a different computer. Drag and drop interactive effect can be implemented using HTML5. Using HTML5 one only needs to send a serial of WebSocket commands, such as virtual mouse cursor location, simulate mouse clicking/dragging, media synchronize timer, etc. between remote UIs. The Web server holds the media files and HTML pages.

When the drag-and-drop function is implemented between UIs, a problem arises in that the mouse moveable ranges on two UIs may not be the same depending on the browser window sizes. In case where the local (second) browser size is smaller than the remote (first) browser size, if the mouse movement is not properly scaled, it could cause confusion of how to display the virtual mouse cursor on the remote (first) screen.

### SUMMARY OF THE INVENTION

The present invention uses remote UI technology to realize a second screen application scenario. That is, a remote UI server can host a first UI for the first screen (device) and a second UI for another screen (device). The present invention uses a browser-based remote UI technology, such as CE-HTML or HTML5, where both UIs are restricted by the browser windows.

The present invention introduces a use case such as in the following example. Tom and his brother are watching TV programs in their home. Tom receives a short message and then he browses the short message on his iPhone. This short message is a rich text message in which several funny pictures are embedded. Tom wants to share these pictures with his brother. He does not need to pass his phone to his brother for viewing. He drags these funny pictures one by one and drops them to the TV icon, and then Tom moves his finger on the screen of his iPhone to place the picture at the proper position on the screen of the TV. Finally Tom's brother can view these pictures on the TV.

Sending a mouse cursor position using an Internet browser-based remote UI is that it does not explicitly define the mouse position in first UI when the mouse comes out of the second UI's browser window, or vice versa. Two UIs may use browsers with different window sizes, which depend on the resolution supported by the monitors (e.g. Digital TV or Laptop Screen) and the window size chosen by the user. The present invention proposes a method to position the virtual mouse cursor on the first UI according to the ratio of the browser window size in the second UI and the browser window size in the first UI.

A method is described including receiving, by a remote browser, local mouse information and local window size, calculating a virtual mouse position and displaying the virtual mouse position on a window of the remote browser. Also described is a method including transmitting local mouse information and local window size to a WebSocket Server. Further described is a method including forwarding by a Web Socket Server local mouse information and local window size to a remote browser.

### BRIEF DESCRIPTION OF THE DRAWINGS

The present invention is best understood from the following detailed description when read in conjunction with the accompanying drawings. The drawings include the following figures briefly described below:

FIG. 1 shows the cursor positions on multiple screens.

FIG. 2 is a flowchart of an exemplary embodiment of the method of the present invention from the perspective of the local computer.

FIG. 3 is a flowchart of an exemplary embodiment of the method of the present invention from the perspective of the WebSocket Server.

FIG. 4 is a flowchart of an exemplary embodiment of the method of the present invention from the perspective of the remote computer.

### DETAILED DESCRIPTION OF THE PREFERRED EMBODIMENTS

The present invention is directed to how to interpret the mouse position in the local browser in order to determine the virtual mouse position on the remote browser. Virtual Mouse cursor positioning is an important feature. In the following, the method is described for supporting related features.

The following pseudo code is executed on the remote computer's remote UI, it returns the virtual cursor's position according to the position of the local mouse cursor position(X, Y).

The input parameters are assigned by a WebSocket command string that is sent by the local Remote UI.

```
class Point {
    private long x;
    private long y;
    public Point(long X, long Y) {
        x = X;
        y = Y;
    }
}
public Point findRemoteXY(long localX, long localY, long localWidth,
        long localHeight) {
    double scaleW = remoteWidth / localWidth;
            double scaleH = remoteHeight / localHeight;
    long remoteX = Math.round(localX * scaleW);
    long remoteY = Math.round(localY * scaleH);
    return new Point(remoteX, remoteY);
}
```

localX is the local mouse current position X on the local browser window. localY is the local mouse current position Y on the local browser window. localWidth is the local browser window width. localHeight is the local browser window height. remoteX is the virtual mouse cursor position X on the remote browser window. remoteY is the virtual mouse cursor position Y on the remote browser window. remoteWidth is the remote browser window width. remoteHeight is the remote browser window height. scaleW is the aspect ratio between localWidth and remoteWidth. scaleH is the aspect ratio between localHeight and remoteHeight.

Once a connection is established between the local laptop (computer, device) and the remote computer (device), the local laptop (computer, device) transmits its local screen height, local screen width, local x position of the cursor and local y position of the cursor. The remote computer (device) calculates a virtual cursor position for the local cursor on the remote computer (device). The remote computer receives the local screen height of the laptop (computer, device), the local screen width of the laptop (computer, device), local x position of the cursor of the laptop (computer, device) and the local y position of the cursor of the laptop (computer, device). The remote computer (device) then calculates a virtual cursor position for the local cursor on the remote computer (device).

The laptop (local device) and the remote computer (device) establish a connection between themselves. The local computer (laptop, device) then transmits the parameters to the remote computer (device) in a function call. In the pseudo-code the remote computer receives the parameters and executes the code for the function call. The remote computer first calculates the scale of the width (scaleW) as remote width (remoteWidth) divided by local width (localWidth) and the scale of the height (scaleH) as remote height (remoteHeight) divided by local height (localHeight). The remoteX is set equal to localX multiplied by (times) scaleW. The remoteY is set equal to localY multiplied by (times) scaleH.

The remote computer (device) executes the function call on a processor in the remote computer. The processor may be a special purpose processor such as an application specific integrated circuit (ASIC) or a field programmable gate array (FPGA) or any other processor capable of executing a function call to determine the virtual cursor position. The local and remote computers may be laptops, computers, personal digital assistants (PDAs), dual mode smart phones, tablet computing devices, digital televisions (TVs) or any other equivalent devices.

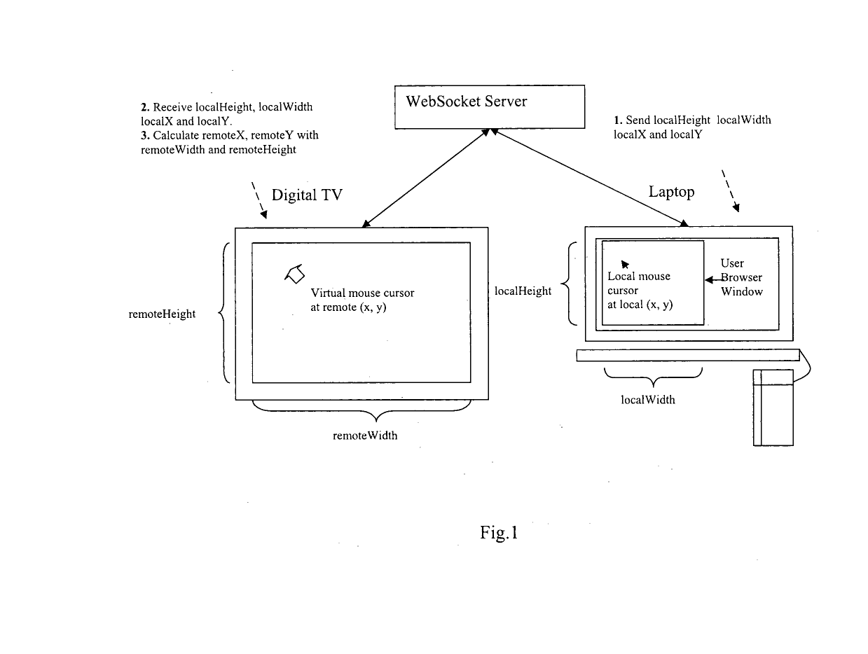

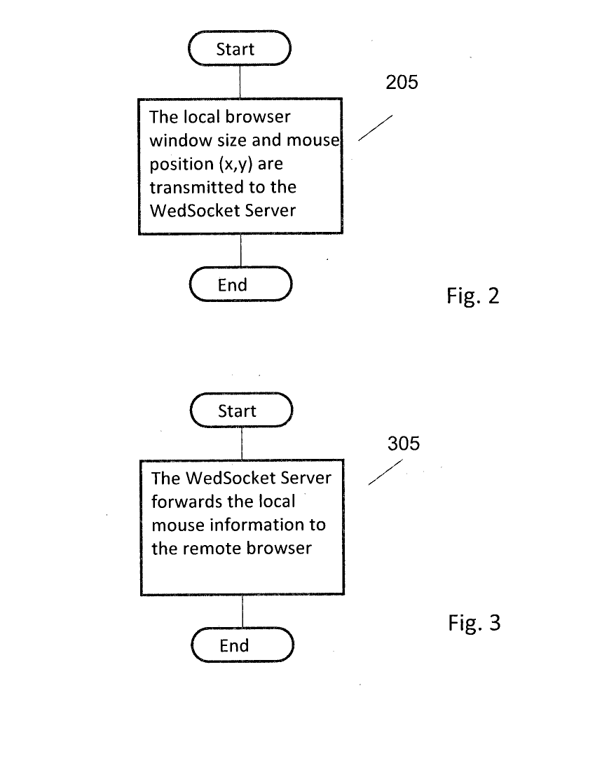

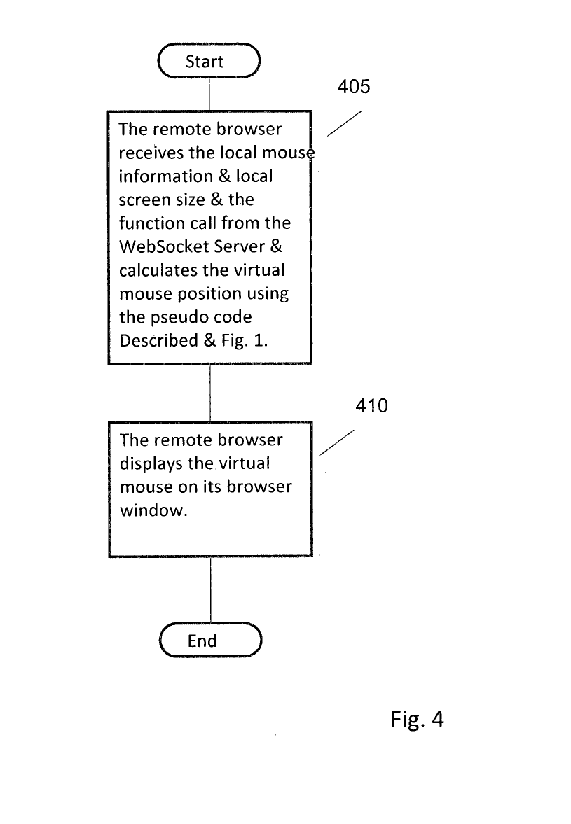

FIG. 1 shows the cursor positions on multiple screens. Both the remote computer (device, laptop) and the local computer (laptop, device) are in communication with the WebSocket Server. Once the local computer (laptop, device) and the remote computer (laptop, device) establish a connection between themselves then the local computer (laptop, device) transmits a function call and parameters to the remote computer (laptop, device). The parameters include localWidth, localHeight, localX and localY. The remote computer (laptop, device) receives the function call and the parameters and then calculates the virtual cursor position for the mouse by executing the code of the function call. All communication is via the WebSocket Server. That is the function call is called by sending (transmitting) the function call and parameters to the remote computer (laptop, device) by the local computer (laptop, device) sending (transmitting) the function call to the WebSocket Server and the WebSocket Server sending the function call and the parameters to the remote computer (laptop, device).

FIG. 2 is a flowchart of an exemplary embodiment of the method of the present invention from the perspective of the local computer (laptop, device). It is assumed that a connection between the remote computer (laptop, device) and the local computer (laptop, device) has been established. At 205 the local browser window size (localWidth and localHeight) and the local cursor position (localX and localY) are sent to the WebSocket Server in a function call.

FIG. 3 is a flowchart of an exemplary embodiment of the method of the present invention from the perspective of the WebSocket Server. At 305, the WebSocket Server forwards (sends, transmits) the information (localWidth, localHeight, localX and localY) to the remote browser in a function call.

FIG. 4 is a flowchart of an exemplary embodiment of the method of the present invention from the perspective of the remote computer. At 405 the remote browser receives the local mouse information and local screen size and the function call form the WebSocket Server and calculates the virtual mouse position (see pseudo code description and FIG. 1). At 410 the remote browser displays the virtual mouse on its browser window. The virtual mouse cursor can reach every corner on the remote browser. The virtual mouse cursor can drag a remote object and drop the object to a local browser window.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method, said method comprising:
receiving, by a remote browser, local mouse information and local window size;
calculating a virtual mouse position; and
displaying said virtual mouse position on a window of said remote browser.

2. The method according to claim 1, wherein said local mouse information and local window size are received as parameters in a function call.

3. The method according to claim 1, wherein said remote browser is executed on a remote computing device.

4. The method according to claim 43, wherein said remote computing device is one of a laptop, a dual mode smart phone, an iPhone, an iPad, an iPod, a tablet device and a television.

5. A method, said method comprising transmitting local mouse information and local window size to a WebSocket Server.

6. The method according to claim 5, wherein said local mouse information and local window size are received as parameters in a function call.

7. (canceled)

8. (canceled)
